(19) United States
(12) Patent Application Publication
(10) Pub. No.: US 2025/0172246 A1
(43) Pub. Date: May 29, 2025

(54) TANK FOR STORING A LIQUEFIED FLUID, ADJUSTING DEVICE, INSTALLATION AND METHOD FOR ASSEMBLING SUCH A TANK

(71) Applicant: L'Air Liquide, Société Anonyme pour I'Etude et I'Exploitation des Procédés Georges Claude, Paris (FR)

(72) Inventors: Marius BOUIN, Sassenage (FR); Pierrick Cohard, Les Abrets (FR)

(21) Appl. No.: 18/962,047

(22) Filed: Nov. 27, 2024

(30) Foreign Application Priority Data
Nov. 28, 2023 (FR) 2313195

(51) Int. Cl. F17C 1/12; F17C 3/08; F17C 13/08

(52) U.S. Cl. CPC F17C 1/12; F17C 3/08; F17C 13/08; F17C 2201/0109; F17C 2201/035; F17C 2201/054; F17C 2203/0391; F17C 2203/0602; F17C 2209/221; F17C 2209/228; F17C 2221/012; F17C 2223/0153; F17C 2223/0161; F17C 2223/033; F17C 2270/0134

(57) ABSTRACT

Tank (1) for storing a liquefied fluid, for example liquid hydrogen, having an inner shell (11) intended to contain the liquefied fluid and an outer shell (12) intended to protect the inner shell (11), the inner shell (11) and the outer shell (12) being spaced apart by a gap (13) provided with a thermal insulation system, the inner shell (11) and the outer shell (12) respectively having an inner tubular central portion (111) and an outer tubular central portion (121) extending in a main direction (X) of the tank (1), the inner shell (11) and the outer shell (12) each also having opposite end-caps, respectively inner end-caps (112a, 112b) and outer end-caps (122a, 122b).

### CROSS REFERENCE TO RELATED APPLICATIONS

This application claims priority to French Patent Application No. 2313195, filed Nov. 28, 2023, the entire contents of each being incorporated herein by reference.

### BACKGROUND

A first aspect of the invention relates to a tank for storing a liquefied cryogenic fluid. The fluid concerned may be liquefied hydrogen.

A second aspect of the invention relates to a device for adjusting the coaxial alignment of such a tank.

A third aspect of the invention relates to an installation comprising such a tank and such a device.

Finally, a fourth aspect of the invention relates to a method for assembling such a tank using such an adjusting device.

The tank for storing a liquefied fluid comprises, in general, an inner shell intended to contain the fluid and an outer shell intended to protect the inner shell. The outer shell and the inner shell are spaced away from each other by a gap provided with a thermal insulation system, for example under vacuum. The inner shell and the outer shell each comprise a tubular central portion, these respectively being an inner tubular central portion and an outer tubular central portion, which extend in the main direction of the tank. Furthermore, the inner shell and the outer shell each have opposite end-caps, these respectively being inner end-caps and outer end-caps.

In order to assemble the tank described above a first end of the outer shell is first of all closed by means of a first end-cap in order to form an outer shell that is open at an opposite second end. Next, the semi-open outer shell is stood vertically in order to receive the inner shell inside it. Finally, the second end is closed in its own turn by means of a second end-cap, before a last step which consists in permanently fixing the outer end-caps to the outer tubular central portion of the outer shell.

For the purposes of this fixing, which may be performed for example by means of welding, the closed outer shell is held in a vertical position with respect to the ground, with one of the outer end-caps in an uppermost position, and the other of the outer end-caps in a lowermost position. The vertical position is favoured because it allows the inner shell to be centred with respect to the outer shell before the outer end-caps are welded to the outer central tubular portion of the outer shell.

While the upper end-cap can be welded to the tubular portion of the outer shell without great difficulty, welding the lower end-cap remains a complex manoeuvre.

As a result, a need has arisen to rethink the design of the storage tank to make it easier to assemble, and notably to make it easier to weld the outer end-caps to the central cylindrical portion of the outer shell.

To this end, a first aspect of the invention relates to a tank for storing a liquefied fluid, in accordance with the generic definition thereof given in the above preamble.

According to this first aspect of the invention, the tank is essentially characterized in that it comprises a boss which is borne by the inner shell and extends into the gap between the inner shell and the outer shell, in a direction perpendicular to the main direction of the tank. The boss is accessible from a re-sealable opening in the outer shell. Furthermore, the boss is configured to cooperate with a third-party device in order to drive the inner shell and the outer shell in a relative movement one with respect to the other in the direction perpendicular to the main direction.

Thus, by providing a boss as described hereinabove, the invention opens up the possibility of adjusting the position of the inner shell with respect to the outer shell by working from outside the tank, and in a direction that makes the operator's manoeuvres easier. The invention also opens up the possibility of maintaining the axial alignment of the inner and outer shells through cooperation between the boss and a third-party device of complementing geometry.

What is meant by a “third-party device” is a device that does not form part of the tank but that is able to cooperate reversibly with the boss in order to make the tank easier to assemble. This may be a device for adjusting the relative coaxial alignment of the outer shell and the inner shell of the tank.

Other embodiments of the tank comprise the features below:
the boss is configured to cooperate by screw-fastening with the third-party device;
the boss has an internal (or external) screw thread intended to cooperate with an external (or internal) screw thread belonging to the third-party device;
the tank comprises a receptacle fixed to the inner shell;
the receptacle forms with the inner shell a casing intended to receive an adsorbent;
the boss is formed on the receptacle;
the boss forms a conduit for the passage of the adsorbent from the opening in the outer shell to the casing;
the receptacle is positioned at one of the inner end-caps of the inner shell;
the receptacle comprises a lateral wall extending in the main direction and a base transverse to the lateral wall;
the boss extends from the lateral wall of the receptacle;
the inner end-caps of the inner shell each bear a first centring member extending in the main direction;
the outer end-caps of the outer shell each bear a second centring member extending in the main direction;
the respective centring members of the inner end-cap and of the outer end-cap which are situated at the one same end of the tank are fitted one inside the other;
the outer shell is equipped with at least one projection intended to receive the third-party device;
the at least one projection of the outer shell is formed in the vicinity of the opening in the outer shell;
the at least one projection of the outer shell comprises an outer branch and an inner branch, the inner branch being shorter than the outer branch;
the branches of the at least one projection of the outer shell are connected to one another by a bridge forming a flat seating surface intended to receive the third-party device.

A second aspect of the invention relates to a device for adjusting the coaxial alignment of a storage tank defined hereinabove. The device comprises:
a support extending in a main direction;
a sleeve configured to be mounted through a passage in the support in a direction perpendicular to the main direction, the sleeve comprising a first end provided with an adjusting member, such as a screw thread;
a handle fixed to the sleeve and intended for turning the sleeve with respect to the support when the device is in use, the handle and the adjusting member being positioned one on each side of the support;
a connecting member configured to fix the sleeve to the support reversibly for the purposes of storing and/or transporting the device.

Other embodiments of the device for adjusting coaxial alignment comprise the features below:
the sleeve has a second end provided with a plate;
the connecting member is configured for fixing the plate to the support;
the support comprises a body comprising two opposite main faces: a first main face and a second main face;
the passage intended to receive the sleeve extends between the two main faces of the support.

A third aspect of the invention relates to an installation comprising a storage tank and an adjusting device both as defined hereinabove.

The support of the adjusting device is configured to rest against the outer shell of the tank. The sleeve of the adjusting device is configured to engage in the opening formed in the outer shell of the tank so as to cooperate with the boss borne by the inner shell of the tank. The handle of the adjusting device is configured for driving the sleeve in a relative movement with respect to the boss.

A fourth aspect of the invention relates to a method for assembling the storage tank as described above. The method uses the device for adjusting coaxial alignment as described above. The method comprises the following successive steps:
a step of closing a first end of the outer shell by fitting a first outer end-cap to form an outer shell that is open at an opposite second end;
a step of inserting the inner shell into the open outer shell;
a step of inserting the adjusting device through the opening in the outer shell, leading to cooperation between the sleeve of the adjusting device and the boss borne by the inner shell;
a step of adjusting the relative coaxial alignment of the inner shell and the outer shell using a relative movement between the sleeve of the adjusting device and the boss borne by the inner shell;
a step of closing the second end of the outer shell by fitting a second outer end-cap.

### BRIEF DESCRIPTION OF THE DRAWINGS

Further particular features and advantages will become apparent upon reading the description below, which is provided with reference to the figures, in which:

FIG. 1 is an isometric view illustrating a storage tank and a device for adjusting coaxial alignment according to the invention, the adjusting device being mounted on the storage tank;

FIG. 2 is an isometric view illustrating a detail from FIG. 1;

FIG. 3 is a two-dimensional cross-sectional view illustrating the tank and the device of FIG. 1, the tank comprising an outer shell and an inner shell;

FIG. 4 is a is a view in cross section illustrating a detail from FIG. 3;

FIG. 5 is an isometric view illustrating the storage tank from FIG. 1 by itself, without the adjusting device;

FIG. 6 is an isometric view illustrating the device from FIG. 1 by itself, without the storage tank;

FIG. 7 is an isometric view illustrating the outer shell from FIG. 2 in a part-open configuration and in a vertical position;

FIG. 8 is an isometric view illustrating the positioning of the inner shell above the open outer shell;

FIG. 9 is an isometric view illustrating the start of insertion of the inner shell into the open outer shell;

FIG. 10 is an isometric view illustrating the storage tank in a horizontal configuration.

### DETAILED DESCRIPTION OF THE PREFERRED EMBODIMENTS

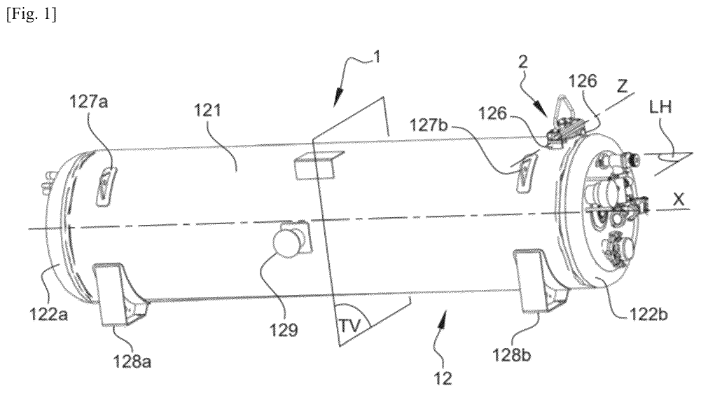

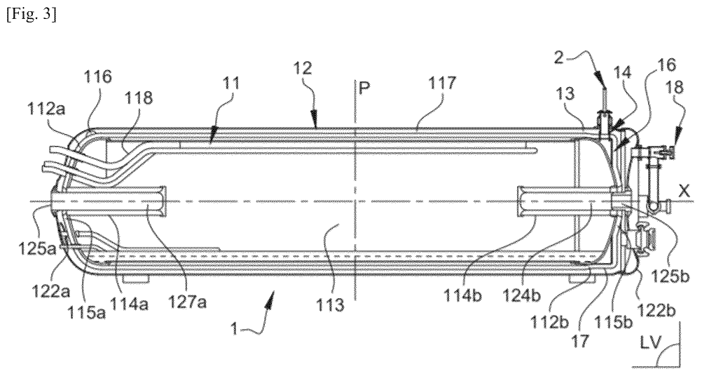

As illustrated in FIG. 1 and FIG. 3, the invention relates to a double-walled storage tank 1 for storing, for example, a cryogenic fluid.

The tank 1 extends in a longitudinal main direction X. Furthermore, the tank 1 has a vertical transverse median plane TV, a vertical longitudinal median plane LV and a horizontal longitudinal median plane LH. The planes TV, LV, LH are defined while considering the main direction X as being parallel to the ground.

With reference to FIG. 3, the tank 1 comprises an inner shell 11 intended to contain the liquefied fluid, and an outer shell 12 covering the inner shell 11. The outer shell 12 is intended to protect the inner shell 11. The inner shell 11 and the outer shell 12 are spaced apart to form a gap 13 provided with a thermal insulation system.

The thermal insulation system may be formed by means of a vacuum created in the gap 13 and/or may contain a thermal insulation, for example of the “multilayer” insulation (MLI) type.

The inner shell 11 and the outer shell 12 each comprise a cylindrical central portion of circular cross section, these respectively being an inner cylindrical central portion 111 and an outer cylindrical central portion 121 which extend in the main direction X of the tank 1. Furthermore, the inner shell 11 and the outer shell 12 each have opposite end-caps, these respectively being inner end-caps 112a, 112b and outer end-caps 122a, 122b. These end-caps 112a, 112b; 122a, 122b may be domed.

The inner central portion 111 and the inner end-caps 112a, 112b of the inner shell 11 form a fluidtight housing 113 intended to contain the fluid. Likewise, the outer central portion 121 and the outer end-caps 122a, 122b of the outer shell 12 form a housing in which the inner shell 11 is placed.

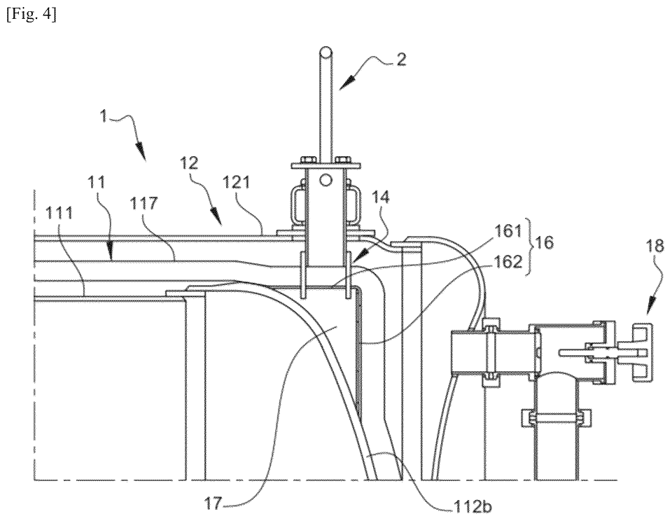

In the embodiment illustrated in FIG. 3 and FIG. 4, the inner end-caps 112a, 112b have a concave face facing toward the outside of the tank 1. One of the outer end-caps 122a, 122b, in this instance the outer end-cap 122b has a concave face facing toward the inside of the tank 1. The other of the outer end-caps 122a, 122b, in this instance the outer end-cap 122a, has a concave face facing toward the outside of the tank 1.

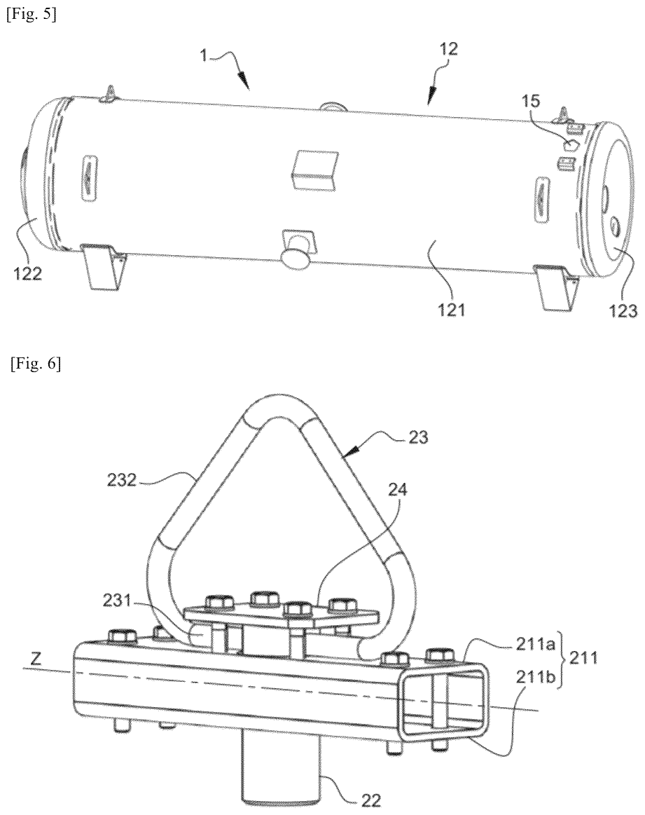

According to the invention, the tank 1 comprises a boss 14 borne by the inner shell 11, in a direction perpendicular to the main direction X of the tank 1 and extending in the gap 13 between the inner shell 11 and the outer shell 12. The boss 14 is accessible from a re-sealable opening 15 formed in the outer shell 12. The opening 15 is visible in FIG. 5. Furthermore, the boss 14 is configured to cooperate with a third-party device 2.

What is meant by a “third-party device” is a device that does not form part of the tank 1 when it is in operation but that can be coupled reversibly with the boss 14 borne by the inner shell 11. The third-party device 2 has a geometry that complements that of the boss 14. It may be a device 2 for adjusting coaxial alignment, as described later on in the description.

Thus, by providing a boss 14 as described hereinabove, the invention opens up the possibility of adjusting the relative position of the inner shell 11 with respect to the outer shell 12 by an operation performed and monitored from outside the tank 1, and in a direction that makes the operator's manoeuvres easier. Furthermore, the invention opens up the possibility of adjusting the relative position of the inner shell 11 with respect to the outer shell 12 using a part of the tank 1, namely the boss 14, which is intended to be hidden in the gap 13 between the inner shell 11 and the outer shell 12.

Advantageously, after the fitting and adjusting operation, the opening 15 in the outer shell 12 is re-sealed in a fluidtight manner by means of a cover so that once this opening 15 has been closed, the boss 14 becomes invisible and inaccessible from outside the tank 1.

Advantageously, as best illustrated in FIG. 3, the inner end-caps 112a, 112b may each be provided with a centring member 114a, 114b which extends in the main direction X of the tank 1, towards the inside of the inner shell 11. The centring members 114a, 114b, these being respectively a first centring member 114a and a second centring member 114b, are therefore arranged facing one another and, more specifically, symmetrically about the vertical transverse median plane TV of the tank 1.

It should be noted that the first centring member 114a and the second centring member 114b may be fixed or secured to the inner end-caps 112a, 112b of the inner shell 11 by mounting supports, these respectively being a first mounting support 115a and a second mounting support 115b.

Still with reference to FIG. 3, the outer end-caps 122a, 122b of the outer shell 12 are each provided with a centring member 124a, 124b which extends in the longitudinal main direction X of the tank 1, towards the inside of the tank 1. These centring members, these being respectively a third centring member 124a and a fourth centring member 124b, are arranged facing one another and, preferably, symmetrically about the median vertical transverse plane TV of the tank 1.

It should be noted that the third centring member 124a and the fourth centring member 124b may be fixed to the outer end-caps 122a, 122b of the outer shell 12 by mounting supports, these respectively being a third mounting support 125a and a fourth mounting support 125b.

The centring members 114a, 114b fixed to the inner end-caps 112a, 112b of the inner shell 11 cooperate respectively with the centring members 124a, 124b fixed to the outer end-caps 122a, 122b of the outer shell 12 so as to centre the inner shell 11 with respect to the outer shell 12. In other words, the centring members 114a, 114b; 124a, 124b cooperate to ensure coaxial alignment between the inner shell 11 and the outer shell 12.

More specifically, the first centring member 114a fixed to the inner end-cap 112a of the inner shell 11 cooperates with the third centring member 124a fixed to the outer end-cap 122a of the outer shell 12. The second centring member 112b fixed to the inner end-cap 112b of the inner shell 11 cooperates with the fourth centring member 124b fixed to the outer end-cap 122b of the outer shell 12.

The centring members 114a, 114b; 124a, 124b also contribute to holding the inner shell 11 in the outer shell 12.

Advantageously, the inner shell 11 may be provided with at least one lifting lug 116 configured to receive a handling cable. Furthermore, the inner shell 11 may be covered with a layer 117 of thermal insulation.

Advantageously, as illustrated in FIG. 3, the tank 1 may also comprise a receptacle 16 fixed to the inner shell 11 to form a casing 17 intended to receive an adsorbent. In particular, the receptacle 16 is fixed at one of the inner end-caps 112a, 112b of the inner shell 11, in this instance at the inner end-cap 112b. The inner shell 11 and the receptacle 16 may thus form a compact subassembly that can be covered with the one same layer 117 of thermal insulation.

With reference to FIG. 4, the receptacle 16 comprises a lateral wall 161 which extends in the main direction X of the tank 1. The receptacle 16 also comprises a base 162 transverse to the lateral wall 161. The lateral wall 161 bears the boss 14.

When the receptacle 16 is present inside the tank 1, the opening 15 in the outer shell 12 may perform an additional function, namely of receiving the adsorbent. Furthermore, the boss 14 may perform an additional function, namely of passing the adsorbent from the opening 15 in the outer shell 12 to the casing 17.

In other words, the arrangement of the receptacle 16 on the inner shell 11 on the one hand, and of the boss 14 on the receptacle 16 on the other hand, simplifies the structure of the tank 1 by giving the boss 14 a dual function: that of receiving a device 2 for adjusting the coaxial alignment and that of allowing the adsorbent to be passed to the casing 17.

Advantageously, the inner shell 11 is equipped with piping 118 intended to supply the storage housing 113 with fluid and/or to withdraw the fluid from this housing 113. This piping 118 may be mounted through one of the inner end-caps 112a, 112b, in this instance the inner end-cap 112a. Furthermore, this piping 118 comprises, for example in each instance, an inner portion extending inside the housing 113 and an outer portion extending outside of the housing 113.

It should be noted that the outer portions of the piping 118 may also be mounted through one of the outer end-caps 122a, 122b of the outer shell 12, in this instance the outer end-cap 122a.

Advantageously, the tank 1 is preferably equipped with a coupling and/or a valve 18 intended to create a vacuum in the gap 13 between the inner shell 11 and the outer shell 12. The valve 18 is positioned for example on one of the outer end-caps 122a, 122b of the outer shell 12, in this instance on the outer end-cap 122a.

Advantageously, with reference once again to FIG. 1, the outer shell 12 may comprise at least a pair of lifting lugs 127a, 127b positioned at the outer central portion 121. The lifting lugs 127a, 127b are configured to receive a cable for handling the tank 1.

In the example illustrated, the outer shell 12 is provided with two pairs of lifting lugs 127a, 127b. The pairs are positioned on each side of the vertical longitudinal median plane LV of the tank 1. Within each pair, the lugs 127a, 127b are arranged one on each side of the vertical transverse median plane TV.

Advantageously, with reference to FIG. 1, the outer shell 12 has at least one pair of feet 128a, 128b positioned at the outer central portion 121. The feet 128a, 128b allow the tank 1 to be stood horizontally on a planar support.

In the example illustrated, the outer shell 12 is provided with two pairs of feet 128a, 128b. The pairs are positioned on each side of the vertical longitudinal median plane LV. Within each pair, the feet 128a, 128b are arranged one on each side of the vertical transverse median plane TV.

Advantageously, with reference to FIG. 1, the outer shell 12 has at least one pair of handling trunnions 129 enabling the tank 1 to be pivoted from a vertical position to a horizontal position or vice versa. The trunnions 129 are positioned at the vertical transverse median plane TV and on each side of the vertical longitudinal median plane LV.

A second aspect of the invention relates to a device 2 for adjusting the relative coaxial alignment of the inner shell 11 and the outer shell 12 of the tank 1 described hereinabove.

With reference to FIG. 6, the adjusting device 2 comprises a support 21 which extends in a main direction Z. The adjusting device 2 also comprises a sleeve 22 mounted through the support 21 in a direction perpendicular to the main direction Z of the support 21. Finally, the device 2 comprises a handle 23 fixed to the sleeve 22 and intended to rest against the support 21.

In particular, the support 21 is intended to be fixed to the central part 121 of the outer shell 12 of the tank 1. After the support 21 has been fixed to the central part 121 of the outer shell 12, the main direction Z of the support 21 is orthogonal to the main direction X of the tank 1 (see FIG. 1).

Furthermore, the support 21 comprises a body 211 which has two opposite main faces: a first main face 211a intended to act as a support for the handle 23, and a second main face 211b intended to be fixed to the central part 121 of the outer shell 12 of the tank 1.

Finally, the support 21 comprises a passage formed through the body 211 of the support 21 perpendicular to the main direction Z of the support 21. The passage extends between the main faces 211a, 211b of the body 211 of the support 21. The passage is intended to receive the sleeve 22.

The sleeve 22 is intended to engage in the opening 15 formed in the outer shell 12 of the tank 1 so as to cooperate with the boss 14 borne by the inner shell 11.

What is meant by “cooperate” is that the sleeve 22 may be fitted into the boss 14 or be slipped over the boss 14 for the purposes of a relative movement between the sleeve 22 and the boss 14 borne by the inner shell 11.

The relative movement between the sleeve 22 of the adjusting device 2 and the boss 14 borne by the inner shell 11 of the tank 1 leads to a relative movement of the inner shell 11 with respect to the outer shell 12 of the tank 1. This relative movement may be a simple translation or a translation/rotation about the main direction of the sleeve 22, causing a translational movement of the inner shell 11 with respect to the outer shell 12 in the main direction of the sleeve 22.

The relative movement between the sleeve 22 of the adjusting device 2 and the boss 14 borne by the inner shell 11 of the tank 1 is made possible by a first adjusting member formed on the sleeve 22 and a second adjusting member formed on the boss 14. In the example illustrated, the first adjusting member is an external screw thread on the sleeve 22. The second guide member is a tapped thread on the boss 14.

The arrangement of guide members as described hereinabove (screw thread on the sleeve 22 and tapped thread on the boss 14) is suitable for an embodiment in which the sleeve 22 is fitted into the boss 14 borne by the inner shell 11 of the tank 1. In an embodiment (not illustrated) in which the sleeve 22 is intended to be slipped over the boss 14 borne by the inner shell 11 of the tank 1, the sleeve 22 may have a tapped thread and the boss may have an external screw thread. In both of the instances hereinabove, the sleeve 22 is intended to cooperate by screw-fastening with the boss 14 borne by the inner shell 11 of the tank 1.

Other types of adjusting member (or types of connection) between the sleeve 22 and the boss 14 may be envisioned for the purposes of causing a translational movement of the inner shell 11 with respect to the outer shell 12 of the tank 1. For example, of the sleeve 22 and the boss 14 one may comprise a stud by way of adjusting member. Of the sleeve 22 and the boss 14 the other may comprise a slot by way of adjusting member. The slot is intended to receive the stud, for example in a bayonet-type connection.

Advantageously, the sleeve 22 has an upper end equipped with a securing plate 24. This plate 24 is fixed reversibly to the support 21 by means of a connecting member. In the example illustrated, the connecting member comprises screws extending parallel to the sleeve 22.

The connecting member thus keeps the sleeve 22 secured to the support 21, for example for the purposes of transporting and/or of storing the adjusting device 2. In other words, the connecting member prevents any movement of the sleeve 22 with respect to the support 21 when the adjusting device 2 is not being used.

In order to use the adjusting device 2, and in particular in order to allow the sleeve 22 to move with respect to the support 21 and with respect to the boss 14, the connecting member that connects the sleeve 22 and the support 21 has to be removed.

The handle 23 comprises a shank 231 that extends through the sleeve 22 and a bow 232 which is connected to the shank 231. In particular, the shank 231 is intended to rest against one of the main faces 211a, 211b of the support 21, in this instance the face 211a. The bow 232 forms a member that can be grasped, intended to make it easier to move the sleeve 22 with respect to the boss 14.

In order to receive the support 21 of the adjusting device 2, the outer shell 12 of the tank 1 is provided with at least two radial projections 126.

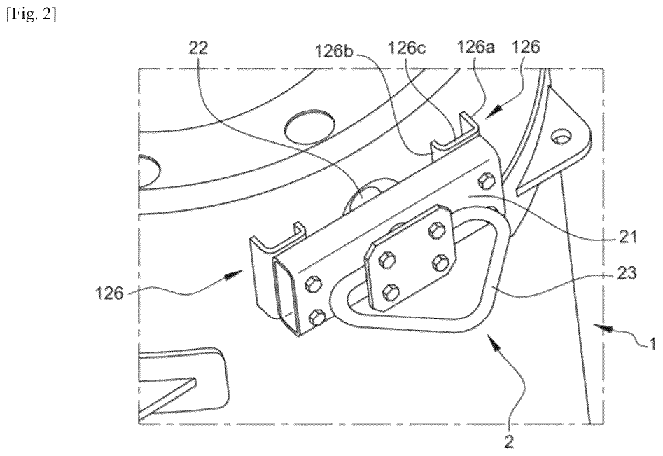

In particular, the radial projections 126 are positioned at the outer central part 121 of the outer shell 12 (see notably FIG. 1 and FIG. 2). Furthermore, the radial projections 126 extend along a periphery of the outer central part 121 of the outer shell 12. Finally, the radial projections 126 are angularly offset from one another about the main direction X of the tank 1.

Advantageously, the radial projections 126 are symmetrical about the vertical longitudinal median plane LV of the tank 1.

With reference to FIG. 2, the radial projections 126 each comprise an outer branch 126a and an inner branch 126b, the branches being connected to one another by a bridge 126c. On each radial projection 126, the outer branch 126a and the inner branch 126b are parallel to one another and perpendicular to the bridge 126c. The bridge 126c forms a flat seating surface able to receive the support 21 of the adjusting device 2. To accomplish this, the inner branch 126b has a height that is less than that of the outer branch 126a.

The terms “inner” and “outer” are defined here with respect to the vertical longitudinal median plane LV of the tank 1 when considering any two arbitrary points situated on a vertical transverse plane. Thus, the term “inner” refers to the point closest to the vertical longitudinal median plane LV. The term “outer” refers to the point furthest from the vertical longitudinal median plane LV.

In order to assemble the tank 1 described hereinabove, the invention introduces an assembly method that employs the coaxial-alignment adjusting device 2 described hereinabove.

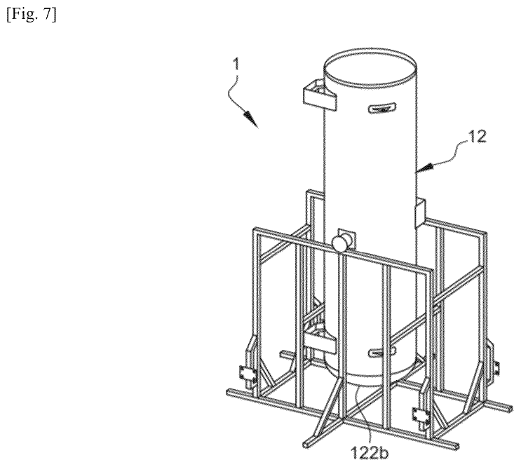

A first step of the method consists in closing a first end of the outer shell 12 by fitting a first outer end-cap 122b. This then yields an outer shell 12 that is open at an opposite second end. The open outer shell 12 is illustrated in FIG. 7.

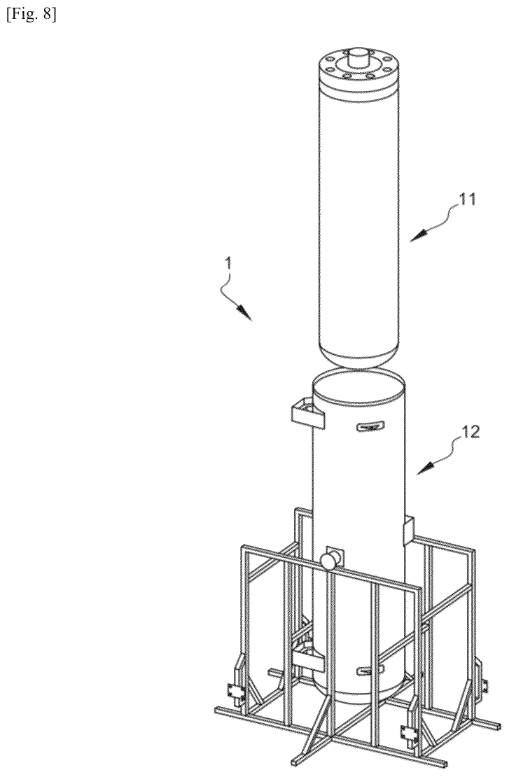

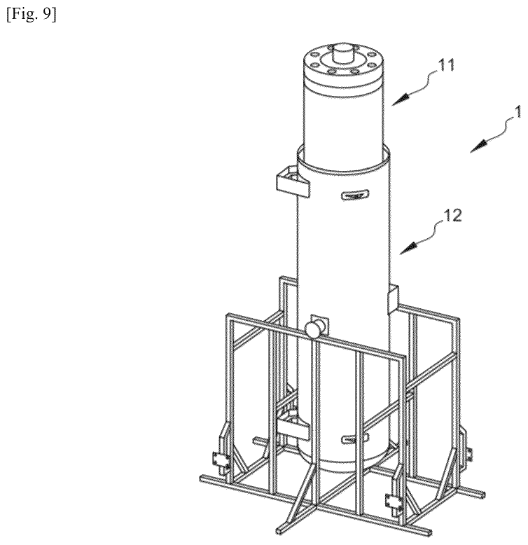

In a second step illustrated in FIG. 8, FIG. 9, the (assembled) inner shell 11 is positioned facing the open outer shell 12, and in particular above the outer shell 12 and is then progressively inserted into same.

For the purposes of this second step, the open outer shell 12 may be arranged perpendicular to the ground. The closed end of the outer shell 12 occupies a lowermost position while the open end of the outer shell 12 occupies an uppermost position. The respective centring members 114b, 124b of the inner end-cap 112b of the inner shell 11 and of the outer end-cap 121b of the outer shell 12 cooperate to centre the inner shell 11 with respect to the outer shell 12.

Advantageously, ahead of this second step, the method may provide an operation of fixing the receptacle 16 to the inner shell 11 of the tank 1, and an operation involving covering the subassembly formed by the inner shell 11 and the receptacle 16 with a layer 117 of thermal insulation.

In a third step, the adjusting device 2 is mounted through the opening 15 in the outer shell 12. Thus, the sleeve 22 of the adjusting device 2 cooperates with the boss 14 borne by the inner shell 11.

In a fourth step, the position of the inner shell 11 with respect to the outer shell 12 is adjusted by moving the one with respect to the other in a direction perpendicular to the main direction X of the tank 1. This alignment seeks to align the inner shell 11 and the outer shell 12 on the one same axis, namely on the main axis X of the tank 1. In other words, this adjustment seeks to render the inner shell 11 and the outer shell 12 coaxial.

It should be noted that the adjusting of the position of the inner shell 11 with respect to the outer shell may be performed by screwing/unscrewing the sleeve 22 of the adjusting device 2 with respect to the boss 14 borne by the inner shell 11 of the tank 1. This screwing/unscrewing generates a force of traction on the inner shell 11 in the main direction of the sleeve 22, tending to move the inner shell 11 with respect to the outer shell 12 in the main direction of the sleeve.

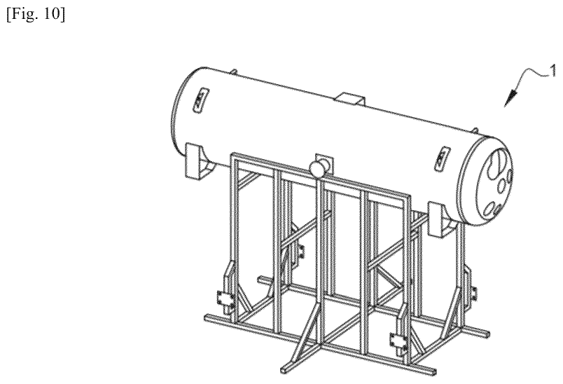

Once the two shells 11, 12 have been rendered coaxial, the method may provide an additional step during which the tank 1 may be pivoted into a horizontal position (see FIG. 10). During this step, the two shells 11, 12 are kept coaxial by cooperation between the sleeve 22 of the adjusting device 2 and the boss 14.

In a fifth step, that end of the outer shell 12 that has hitherto remained open is in its own turn closed by fitting the second outer end-cap 122a. This then yields a fully-closed outer shell 12 housing an inner shell 11 and a receptacle 16.

With the tank 1 arranged horizontally, the method provides a sixth step during which the outer end-caps 122a, 122b may be welded to the outer central portion 121 of the outer shell 12 for permanent attachment. Welding performed on a tank 1 arranged horizontally is easier than welding performed on a tank arranged vertically.

Finally, after the outer end-caps 122a, 122b have been welded to the outer central part 121 of the outer shell 12, the adjusting device 2 may be withdrawn from the tank 1. The opening 15 providing access to the boss 14 may then be re-sealed by means of a stopper (not illustrated) thus concealing the boss 14.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A tank for storing a liquefied fluid, comprising an inner shell configured to contain the liquefied fluid and an outer shell configured to protect the inner shell, the inner shell and the outer shell being spaced apart by a gap provided with a thermal insulation system, the inner shell and the outer shell respectively comprising an inner tubular central portion and an outer tubular central portion extending in a main direction of the tank, the inner shell and the outer shell each also comprising opposite end-caps, respectively inner end-caps and outer end-caps,
the tank further comprising a boss borne by the inner shell, in a direction perpendicular to the main direction and extending in the gap between the inner shell and the outer shell, the boss being accessible from a re-sealable opening in the outer shell, the boss being configured to cooperate with a third-party device so as to drive the inner shell and the shell in a relative movement one with respect to the other in the direction perpendicular to the main direction,
further comprising a receptacle fixed to the inner shell and forming with the inner shell a casing configured to receive an adsorbent, the boss being formed on the receptacle and forming a conduit for the passage of the adsorbent from the opening in the outer shell to the casing.

2. The tank according to claim 1, wherein the boss is configured to cooperate by screw-fastening with the third-party device, the boss having an internal (or external) screw thread intended to cooperate with an external (or internal) screw thread belonging to the third-party device.

3. The tank according to claim 1, wherein the receptacle is positioned at one of the inner end-caps of the inner shell, the receptacle comprising a lateral wall extending in the main direction and a base) transverse to the lateral wall, the boss extending from the lateral wall of the receptacle.

4. The tank according to claim 1, wherein the inner end-caps of the inner shell each bear a first centring member extending in the main direction, and in that the outer end-caps of the outer shell each bear a second centring member extending in the main direction, the respective centring members of the inner end-cap and of the outer end-cap which are situated at the one same end of the tank being fitted one inside the other.

5. The tank according to claim 1, wherein the outer shell is equipped with at least one projection configured to receive the third-party device, the at least one projection being formed in the vicinity of the opening in the outer shell and comprising an outer branch and an inner branch, the branches being connected to one another by a bridge forming a flat seating surface intended to receive the third-party device, the inner branch being shorter than the outer branch.

6. A device for adjusting coaxial alignment configured for a storage tank according to claim 1, the device comprising:
a support) extending in a main direction;
a sleeve configured to be mounted through a passage in the support in a direction perpendicular to the main direction, the sleeve comprising a first end provided with an adjusting member;
a handle fixed to the sleeve and configured for turning the sleeve with respect to the support when the device is in use, the handle and the adjusting member being positioned on either side of the support in the main direction;
a connecting member configured to fix the sleeve to the support reversibly for the purposes of storing and/or transporting the device.

7. The device according to claim 6, wherein the sleeve has a second end provided with a plate, the connecting member being configured for fixing the plate to the support.

8. The device according to claim 6, wherein the support comprises a body comprising two opposite main faces: a first main face and a second main face, and in that the passage intended to receive the sleeve extends between the two main faces of the support.
